(19) United States
(12) Patent Application Publication
(10) Pub. No.: US 2016/0180174 A1
(43) Pub. Date: Jun. 23, 2016

(54) COMMODITY REGISTRATION DEVICE AND COMMODITY REGISTRATION METHOD

(71) Applicant: CASIO COMPUTER CO., LTD., Tokyo (JP)

(72) Inventors: Shigeki ENOMOTO, Toda-shi (JP); Yoshihiro SATO, Asaka-shi (JP)

(73) Assignee: CASIO COMPUTER CO., LTD., Tokyo (JP)

(21) Appl. No.: 14/936,454

(22) Filed: Nov. 9, 2015

(30) Foreign Application Priority Data
Dec. 17, 2014 (JP) 2014-255521

(51) Int. Cl. G06K 9/00; H04N 5/232; G10L 15/22

(52) U.S. Cl. CPC G06K 9/00771; G10L 15/22; H04N 5/23203; G10L 2015/223

(57) ABSTRACT

A commodity registration device according to the present invention includes: a photographing unit that photographs an object as an image; a voice input unit that receives a voice; and a control unit that recognizes a commodity by using, as auxiliary information to recognize the object as a commodity, the voice received from the voice input unit during a predetermined period before and after timing including the timing of detecting that the object is photographed by the photographing unit as the image.

### BACKGROUND OF THE INVENTION

1. Field of the Invention

The present invention relates to a commodity registration device and a commodity registration method.

2. Background Art

In the related art, an electronic cash register (commodity registration device) reads a data code, such as a bar code assigned to a commodity, by a bar code reading unit, and identifies the commodity. The bar code assigned to the commodity is formed by including maker code information, item code information, and check digit information. The commodity registration device determines that a bar code is correctly read by the check digit information, and then identifies the commodity by the item code information. A burden on an operator at a cash register can be reduced by preliminarily printing the bar code on a package of the commodity.

However, for a commodity that is not packaged such as fruits and vegetables, individually attaching a bar code to each one thereof is extremely complicated and requires long time and cost. As for such fruits and vegetable, a system in which an operator inputs a commodity code and a price by a keyboard is adopted in the related art.

In recent years, it is becoming common to use a commodity registration device that identifies the fruits, vegetables, etc. by recognizing them as objects, and registers sales of the identified commodities. Such a commodity registration device extracts an appearance feature amount from information of an image obtained by photographing a fruit or a vegetable, and compares the appearance feature amount with a feature database preliminarily prepared, thereby identifying which commodity the object is. According to this technology, the commodity registration device can recognize even a commodity not packaged in advance without attaching a bar code to each one thereof. As a result, a burden on a shop side can be reduced.

For example, JP 2013-89258 A discloses an information processor that compares image information of a target image captured by an imaging unit with reference image information of each one of the commodities, and then displays, on a display unit, a commodity corresponding to reference image information having a similarity level within a predetermined range as a candidate commodity.

However, according to the information processor disclosed in JP 2013-89258 A, an operator needs to selectively operate a keyboard or a touch screen in the case where the captured target images are highly similar to each other (for example, apples or oranges from different production area). For example, in the case of registering, as a commodity, the commodity “orange” from a plurality of production areas, such as Wakayama (Unshu), Ehime, etc, it is difficult to determine the respective production areas of the “orange” by image recognition. Therefore, the operator needs to once stop image reading operation and selectively operate the keyboard or the touch screen.

Further, in the case of wishing to additionally register a plurality of commodities same as the commodity already recognized, the same recognizing operation must be repeated before settlement. Also, the same operation is required for cancellation as well.

Thus, in the case of wishing to perform additional registration/cancellation for the commodities similar to each other and having the plurality of production areas like fruits and vegetables not attached with bar codes, the operator must return to keyboard operation or the like. Therefore, there is a problem in which work efficiency is degraded.

### SUMMARY OF THE INVENTION

The present invention is directed to improving work efficiency of commodity sales registering operation.

A commodity registration device according to the present invention includes: a photographing unit that photographs an object as an image; a voice input unit that receives a voice; and a control unit that recognizes a commodity by using, as auxiliary information to recognize the object as a commodity, the voice received from the voice input unit during a predetermined period before and after timing including the timing of detecting that the object is photographed by the photographing unit as the image.

A commodity registration method according to the present invention includes steps of: photographing an object as an image; receiving a voice; and performing control to recognize a commodity by using, as auxiliary information to recognize the object as a commodity, the voice received at the step of receiving a voice during a predetermined period before and after timing including the timing of detecting that the object is photographed in the step of photographing as the image.

According to the present invention, efficiency of commodity sales registering operation can be improved.

### BRIEF DESCRIPTION OF THE DRAWINGS

FIG. 1 is a perspective view illustrating external appearance of a commodity registration device according to the present embodiment;

FIG. 2 is a configuration diagram schematically illustrating the commodity registration device according to the present embodiment;

FIG. 3 is a functional block diagram schematically illustrating the commodity registration device according to the present embodiment;

FIG. 4 is a front view of a commodity identification device according to the present embodiment;

FIG. 5 is a diagram illustrating an exemplary feature amount file according to the present embodiment;

FIGS. 6A and 6B are flowcharts illustrating commodity registration processing according to the present embodiment;

FIG. 7 is a diagram illustrating an exemplary voice recognition buffer of the commodity registration device according to the present embodiment;

FIGS. 8A to 8C are diagrams illustrating exemplary commodity confirmation screens displayed on a display of the commodity registration device according to the present embodiment; and

FIGS. 9A to 9D are timing charts to describe a commodity registration method in the commodity registration device according to the present embodiment.

### DETAILED DESCRIPTION OF THE PREFERRED EMBODIMENT

An embodiment to implement the present invention will be described below in detail with reference to the respective drawings. Note that a same element is denoted by a same reference sign even though the element is illustrated in a different drawing, and repetition of the same description may be omitted.

### EMBODIMENT

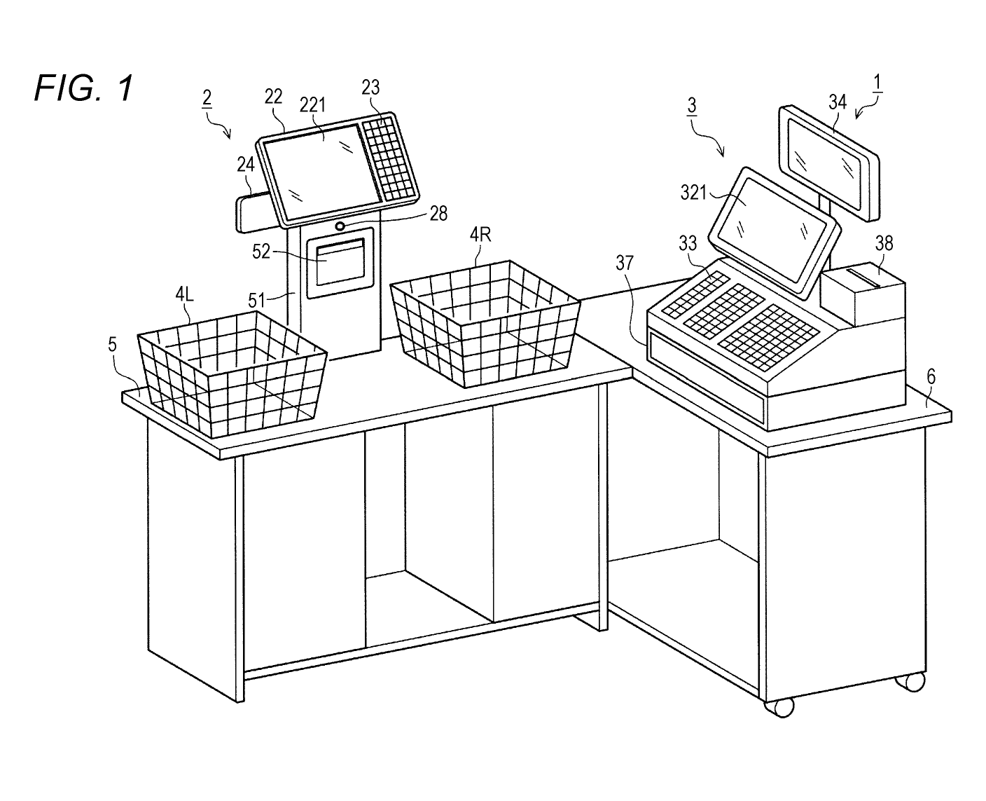

FIG. 1 is a perspective view illustrating external appearance of a commodity registration device 1 according to an embodiment of the present invention.

As illustrated in FIG. 1, the commodity registration device 1 includes a commodity identification device 2 to register each commodity, and a POS terminal 3 to perform commodity sales registration and settlement related to each transaction. The commodity identification device 2 is a scanner to be connected to a POS that reads and registers information related to a commodity.

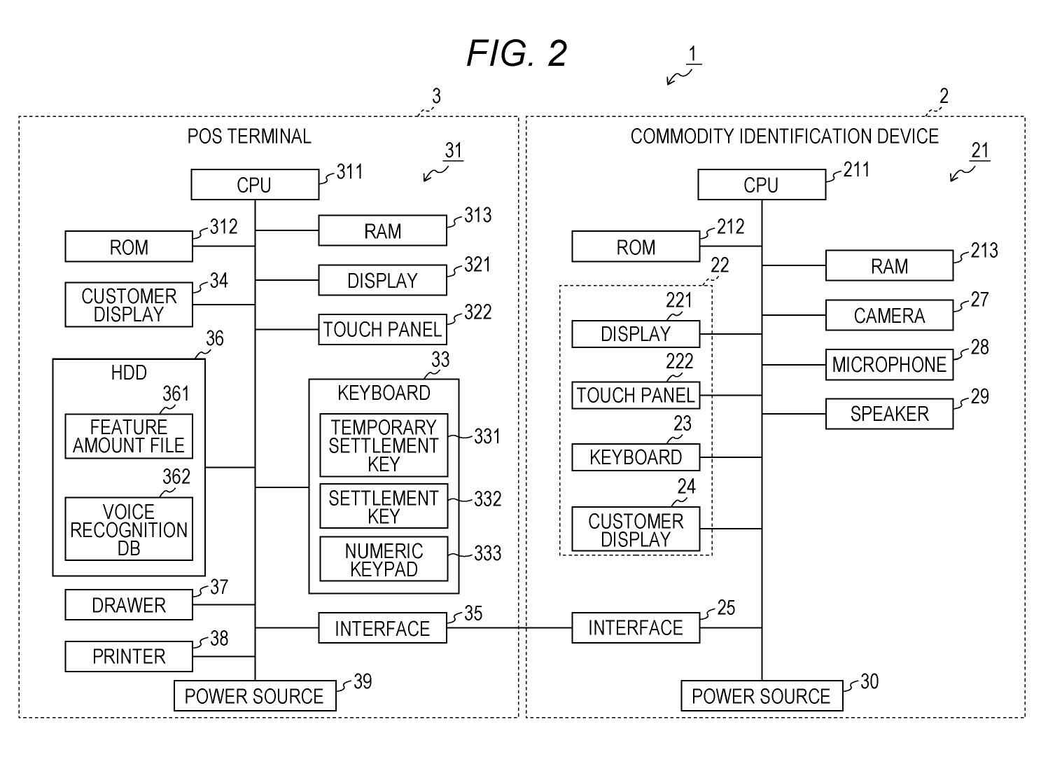

The commodity identification device 2 is disposed at the center in a longitudinal direction of a counter table 5 having a horizontally long shape. The commodity identification device 2 includes a housing 51 having a shape of a thin rectangular parallelepiped. A camera 27 is disposed on a front surface of the housing 51 via a reading window 52 (refer to FIG. 2). A microphone 28 is disposed above the reading window 52.

A display/operation unit 22 is mounted above the housing 51. The display/operation unit 22 is provided with a display 221. A touch panel 222 is superimposed on a surface of the display 221 (refer to FIG. 2). A keyboard 23 is disposed on the right side of the display 221. A card reading groove of a card reader not illustrated is disposed on the right side of the keyboard 23. A customer display 24 for providing information to a customer is disposed on a left back side of the display/operation unit 22 with a back surface thereof facing the display/operation unit 22.

The POS terminal 3 is placed on an upper surface of a drawer 37 on a checkout counter 6. Open operation of the drawer 37 is controlled by the POS terminal 3.

A keyboard 33 to be operated by an operator (shop staff) is disposed on an upper surface of the POS terminal 3. A display 321 to display information is disposed on upper back side of the keyboard 33 from the operator's view. A touch panel 322 is superimposed on a surface of the display 321 (refer to FIG. 2). A customer display 34 to display information is set on a more back side of the display 321 in a manner rotatable in a horizontal direction. Meanwhile, the customer display 34 illustrated in FIG. 1 faces the near side in FIG. 1. The customer display 34 displays information to a customer by being rotated so as to face the back side of the FIG. 1.

The horizontally long-shaped counter table 5 is disposed in a manner forming an L-shape with the checkout counter 6 where the POS terminal 3 is placed. A load receiving surface is formed on an upper surface of counter table 5. While a customer moves from left to right in FIG. 1, the customer receives commodity registration processing. In other words, a first shopping basket 4L to store a commodity and a second shopping basket 4R are placed on the load receiving surface of the counter table 5. When the first shopping basket 4L is not distinguished from the second shopping basket 4R, both shopping baskets may be simply referred to as shopping baskets 4. These shopping baskets 4 are not limited to have a so-called basket shape, and a tray or the like may be used as well. Further, the shopping baskets 4 are not limited to have the so-called basket, and a box, a bag, or the like may be used as well.

The first shopping basket 4L is brought by a customer, and a commodity related to one transaction is stored. The second shopping basket 4R is placed at a position interposing the commodity identification device 2 in a space with the first shopping basket 4L. The commodity inside the first shopping basket 4L is taken out by an operator operating the commodity identification device 2, and moved to the second shopping basket 4R. In the course of this movement, the commodity is held over the reading window 52 of the commodity identification device 2. At this point, the camera 27 disposed inside the reading window 52 captures an image of the commodity (refer to FIG. 2).

In the commodity identification device 2, a screen is displayed on the display 221 in order to specify which one of commodities recorded in a feature amount file 361 described later (refer to FIG. 2) the commodity included in the image captured by the camera 27 corresponds to. Further, the commodity identification device 2 notifies the POS terminal 3 of a commodity ID of the specified commodity. The POS terminal 3 records, in a sales master file (not illustrated), information related to sales registration for the commodity corresponding to the commodity ID, such as a commodity category, a commodity name, a unit price, etc., based on the commodity ID notified from the commodity identification device 2, and then performs sales registration.

FIG. 2 is a configuration diagram schematically illustrating the commodity registration device 1 according to the present embodiment. The commodity registration device 1 is formed by including the commodity identification device 2 and the POS terminal 3. The commodity identification device 2 is formed by including a microcomputer 21, the display/operation unit 22, an interface 25, the camera 27, a speaker 29, and a power source 30. The microcomputer 21 is formed by connecting read only memory (ROM) 212 and random access memory (RAM) 213 to a central processing unit (CPU) 211 via a bus. The ROM 212 stores a program executed by the CPU 211.

The CPU 211 is connected to the display/operation unit 22, interface 25, camera 27, microphone 28, and speaker 29 via an internal bus and via respective input/output circuits (not illustrated).

The display/operation unit 22 is formed by including the display 221, touch panel 222, customer display 24, and keyboard 23, and operation is controlled by the CPU 211.

The display 221 displays information for the operator in accordance with a command of the CPU 211. The touch panel 222 receives input of operation relative to the information displayed by the display 221. The customer display 24 displays information for the customer in accordance with a command of the CPU 211.

The keyboard 23 includes a plurality of operation keys, and receives input of the operator's operation.

The interface 25 is connected to an interface 35 of the POS terminal 3, thereby enabling data exchange with the POS terminal 3.

The camera 27 is a color CCD image sensor or a color CMOS image sensor, which is an imaging unit to capture an image from the reading window 52 (refer to FIG. 1) under control of the CPU 211. The camera 27 captures a moving image at 30 fps, for example. The frame images (captured images) sequentially captured by the camera 27 at a predetermined frame rate are stored in the RAM 213.

The microphone 28 receives a voice uttered from an operator. The microphone 28 is assumed to receive the operator's voice by being disposed above the reading window 52 of the commodity identification device 2.

The speaker 29 generates a preset warning sound and the like. The speaker 29 provides notification by using a warning sound or a voice under the control of the CPU 211.

The power source 30 supplies power to respective components of the commodity identification device 2.

The interface 25 is connected to an interface 35 of the POS terminal 3, thereby enabling data exchange with the POS terminal 3.

The POS terminal 3 is formed by including a microcomputer 31, the display 321, the touch panel 322, the keyboard 33, the customer display 34, the interface 35, a hard disk drive (HDD) 36, the drawer 37, a printer 38, and a power source 39.

The microcomputer 31 executes information processing. The microcomputer 31 has the ROM 312 and the RAM 313 connected, via a bus, to a CPU 311 that executes various kinds of calculation processing and controls respective portions. The CPU 311 is connected to the drawer 37, keyboard 33, display 321, touch panel 322, customer display 34, and HDD 36 via an internal bus and via respective input/output circuits. These components are controlled by the CPU 311.

The display 321 displays information for the operator by a command of the CPU 311. The touch panel 322 receives input of operation relative to the information displayed by the display 321. The customer display 34 displays information for the customer in accordance with a command of the CPU 311.

The keyboard 33 includes a temporary settlement key 331, a settlement key 332, and a numeric keypad 333, and receives input of the operator's operation. The numeric keypad 333 includes number keys from 0 to 9 and various kinds of operator keys.

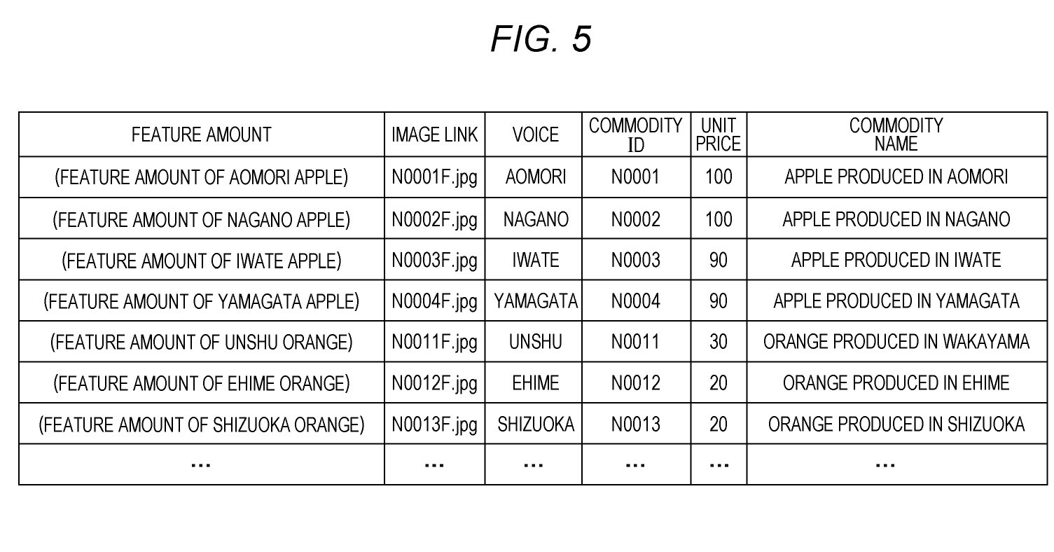

The HDD 36 stores a program and various kinds of files. The program and the various kinds of files stored in the HDD 36 are entirely or partly copied in the RAM 313 and executed by the CPU 311 at the time of starting the POS terminal 3. For example, the feature amount file 361 is stored in the HDD 36, but a program for commodity sales data processing may also be recorded. The feature amount file 361 is a commodity file in which information related to commodity sales registration is associated with an image of the commodity for each of handling commodities to be displayed and sold in a shop. Further, the feature amount file functions as a dictionary of the handling commodities (refer to FIG. 5).

The interface 35 is connected to the commodity identification device 2, thereby enabling data exchange with the commodity identification device 2.

The printer 38 performs printing on a receipt and the like. The POS terminal 3 prints, on a receipt, transaction details of each transaction under control of the CPU 311.

The power source 39 supplies power to the respective components of the POS terminal 3.

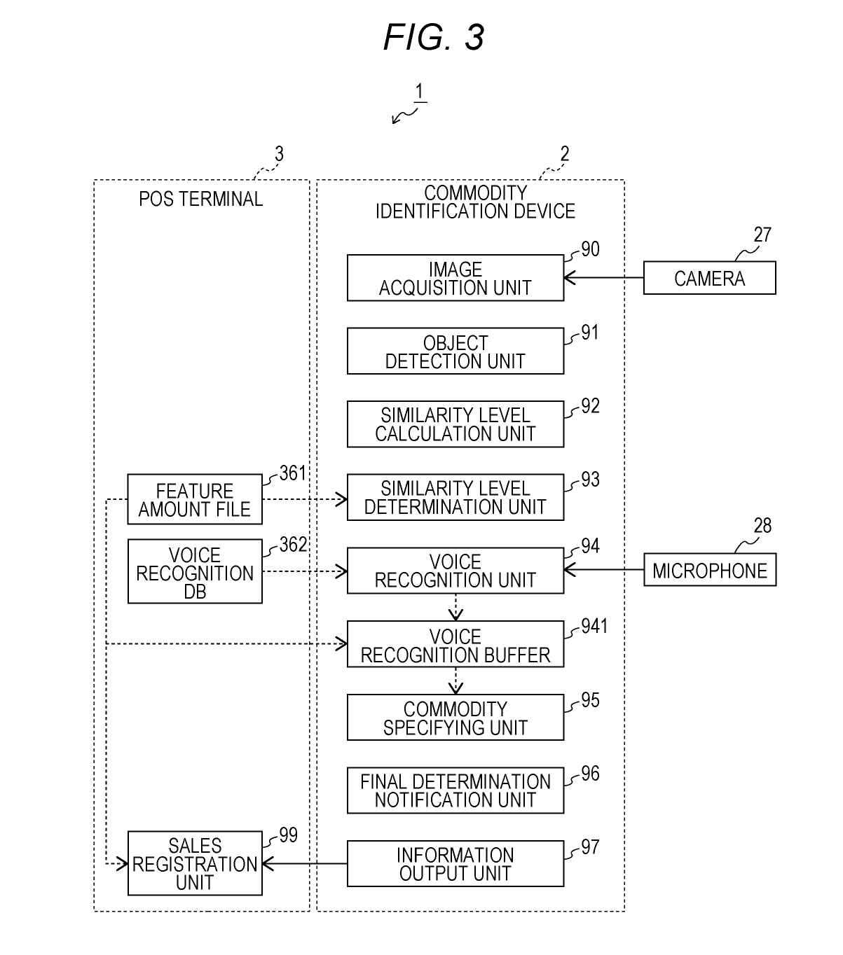

FIG. 3 is a functional block diagram schematically illustrating the commodity registration device 1 according to the present embodiment. The following description will be provided by timely referring to FIGS. 1 and 2.

The CPU 211 of the commodity identification device 2 implements, by executing the program stored in the ROM 212, respective units including an image acquisition unit 90, an object detection unit 91, a similarity level calculation unit 92, a similarity level determination unit 93, a voice recognition unit 94, a voice recognition buffer 941, a commodity specifying unit 95, a final determination notification unit 96, and an information output unit 97. Further, in the same manner, the CPU 311 of the POS terminal 3 implements respective portions of a sales registration unit 99 by executing the program stored in the HDD 36. Further, the HDD 36 of the POS terminal 3 stores the feature amount file 361 and a voice recognition DB 362.

The image acquisition unit 90 outputs an imaging ON signal to the camera 27 and makes the camera 27 start imaging operation. Further, the image acquisition unit 90 sequentially acquires frame images captured by the camera 27 and stored in the RAM 213. The image acquisition unit 90 acquires the frame images in the order of being stored in the RAM 213.

The object detection unit 91 detects an entire or a part of an object included in a frame image acquired by the image acquisition unit 90 by using a pattern matching technique.

More specifically, when the operator directs the commodity to the reading window 52 for sales registration, the image acquisition unit 90 photographs the image of the commodity by the camera 27. The object detection unit 91 extracts a contour by binarizing the acquired frame image. Next, the object detection unit 91 compares the contour extracted from the current frame image with a contour extracted from a previous frame image, and detects an object corresponding to the commodity.

In the following, another specific method will be described. When the operator holds a commodity with hands and directs the commodity to the reading window 52 for sales registration, the image acquisition unit 90 photographs the image of the commodity and the hands by the camera 27. The object detection unit 91 detects presence of a skin color area from the acquired frame image. In the case of detecting the skin color area, i.e., in the case of detecting the hands of the shop staff, the object detection unit 91 detects a contour in the vicinity of the skin color area. By this, the contour of the commodity seeming to be held by the hands of the operator is extracted. In the case of detecting the contour of a shape of the hands and further detecting a contour of an object excluding the hands in the vicinity of the contour of the hands, the object detection unit 91 detects the commodity from the contour of the object.

The similarity level calculation unit 92 reads, as a feature amount, a color shade and a surface condition, such as unevenness condition of the surface, of the commodity based on the image of the commodity captured by the camera 27. The similarity level calculation unit 92 disregards the contour and the size of the commodity. By this, the similarity level calculation unit 92 can shorten the processing time.

The similarity level calculation unit 92 further reads, as the feature amount, the color shade and the surface condition, such as unevenness condition of the surface, of the commodity based on a commodity image of each of the commodities recorded in the feature amount file 361 (hereinafter referred to as handling commodities), and compares the feature amount of the photographed commodity with the feature amount of each of the handling commodities, thereby calculating a similarity level between the photographed commodity and the handling commodities recorded in the feature amount file 361. The similarity level here represents how similar an entire or a part of the image of the commodity is in the case of setting a similarity level, to 100%, of a commodity image assumed by each of the commodities recorded in the feature amount file 361. Meanwhile, the similarity level calculation unit 92 may calculate the similarity level by, for example, changing weights between the color shade and the unevenness condition of the surface.

Recognizing thus the object included inside the image is referred to as generic object recognition. In “The Current State and Future Directions on Generic Object Recognition” written by YANAI KEIJI, survey of generic object recognition research is added to the method and further datasets and evaluation benchmarks are carried out, and moreover, future directions in this technique is discussed.

“The Current State and Future Directions on Generic Object Recognition” by YANAI KEIJI, [online], pages 1 to 24, Vol. 48, No. SIG16 of the journal issued on Nov. 15, 2007 from Information Processing Society of Japan (searched on Sep. 8, 2014): Internet <URL: http://mm.cs.uec.ac.jp/IPSJ-TCVIM-Yanai.pdf>

Further, a technique of performing the generic object recognition by dividing an image per object is described in a literature below.

“Semantic Texton Forests for Image Categorization and Segmentation” by Jamie Shotton et al., Computer Vision and Pattern Recognition, 2008. CVPR 2008. IEEE Conference on (searched on Sep. 8, 2014) Internet <URL: http://citeseerx.ist.psu.edu/viewdoc/download?doi=10.1.1.145.3036&rep=rep1& type=pdf>

Note that any kind of technique can be applied as a calculation method for a similarity level between a captured commodity image and a commodity image of a handling commodity recorded in the feature amount file 361. For example, the similarity level between the captured commodity image and each of the handling commodities recorded in the feature amount file 361 may be calculated as absolute evaluation or may be calculated as relative evaluation.

In the case of calculating the similarity level as the absolute evaluation, the captured commodity image and each of the handling commodities recorded in the feature amount file 361 are compared on a one-to-one basis, and a similarity level obtained by this comparison is adopted as it is. Further, in the case of calculating the similarity level as the relative evaluation, calculation is made such that a sum of similarity levels with the respective handling commodities becomes 1.0 (100%). For example, assume that there are four commodities #1 to #4 recorded in the feature amount file 361. In this case, a similarity level of a captured commodity is calculated as follows, for example: the similarity level to the commodity #1 is 0.65, the similarity level to the commodity #2 is 0.2, the similarity level to the commodity #3 is 0.1, and the similarity level to the commodity #4 is 0.05.

The similarity level determination unit 93 compares, per frame image acquired by the image acquisition unit 90, the similarity level of the commodity image with the commodity image recorded in the feature amount file 361. According to the present embodiment, a plurality of conditions is provided relative to the similarity level between the commodity image of the handling commodity and the photographed commodity image. The similarity level determination unit 93 finally determines a handling commodity or selects a candidate commodity in accordance with these satisfied conditions. The conditions related to the similarity level are not particularly limited, but a case of using conditions X, Y, Z will be described below.

Here, the condition X and the condition Y are used in order to finally determine an object on a frame image as one of the handling commodities recorded in the feature amount file 361. Further, the condition Z is used in order to extract a candidate handling commodity recorded in the feature amount file 361 based on the object on the frame image.

For example, the similarity level determination unit 93 determines a handling commodity satisfying the condition X and/or the condition Y as the commodity corresponding to the object on the frame image on one-to-one basis. Further, the similarity level determination unit 93 determines that a handling commodity satisfying the condition Z is not a finally determined commodity but a candidate commodity captured by the camera 27. Further, the similarity level determination unit 93 extracts the handling commodity satisfying the condition Z from among the plurality of handling commodities recorded in the feature amount file 361, thereby extracting the candidate handling commodity corresponding to the photographed commodity.

The details of the conditions X to Z are not particularly limited as far as the conditions are set stepwisely in accordance with the similarity levels. As an example, the conditions X to Z can be provided by a plurality of preset thresholds. Here, a case where the conditions X to Z are set by thresholds Tx to Tz will be described. Note that the threshold Tx to Tz becomes smaller in this order.

The similarity level determination unit 93 counts the number of times the similarity level with the handling commodity becomes the preset threshold Tx or more, and determines that the condition X is satisfied in the case where the number of times reaches a predetermined times or more.

Further, the similarity level determination unit 93 determines that the condition Y is satisfied in the case where the similarity level with the handling commodity is less than the threshold Tx and also the threshold Ty or more. Further, the handling commodity satisfying the condition Y is determined as a finally determined commodity but confirming operation by the operator is required.

Additionally, the similarity level determination unit 93 determines that the condition Z is satisfied in the case where the similarity level with the handling commodity is less than the threshold Ty and also the threshold Tz or more.

Meanwhile, the respective conditions X to Z can be suitably set in accordance with amplitude of the similarity level or the like, and are not limited to the above example.

Thus, the similarity level determination unit 93 reads out, from the feature amount file 361, a photograph image and a commodity name of the handling commodity that satisfies the condition Z, and outputs the same as a candidate commodity in the order of having higher similarity level calculated by the similarity level calculation unit 92.

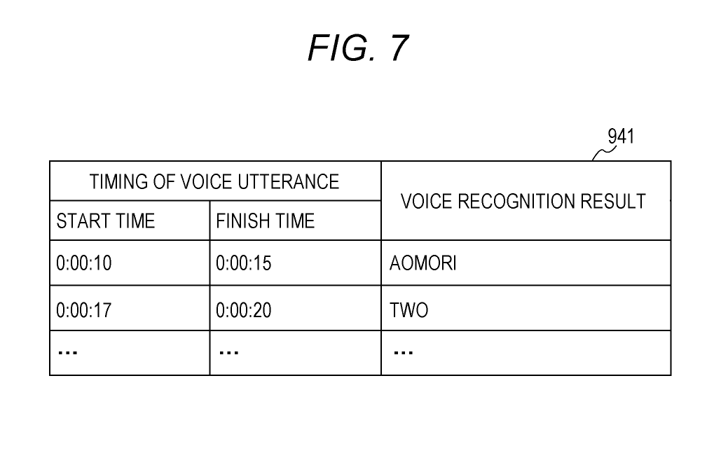

The voice recognition unit 94 recognizes an uttered voice by referring to the voice recognition DB 362. More specifically, the voice uttered by the operator is taken into the voice recognition unit 94 from the microphone 28 as a voice signal, and the voice recognition unit 94 analyzes waveforms of the voice signal and extracts a feature pattern. Then, the voice recognition unit 94 recognizes the voice and temporarily stores a voice recognition result in the voice recognition buffer 941 (refer to FIG. 7). As illustrated in FIG. 7, the voice recognition buffer 941 stores timing of operator's voice utterance (start time and finish time of voice receiving) as well as the voice recognition result of the voice received at the timing of voice utterance.

In this example, a voice recognition result “AOMORI” of a voice signal of a voice received from the start time 0:00:10 to the finish time 0:00:15 is stored. In next timing of voice utterance, a voice recognition result of “FUTATSU” of a voice signal of a voice received from the start time 0:00:17 to the finish time 0:00:20 is stored.

The commodity specifying unit 95 specifies, based on the voice recognition by the voice recognition unit 94, a commodity or the number of commodity from among candidate commodities for the commodity recognized as the object by the similarity level determination unit 93.

More specifically, the commodity specifying unit 95 specifies the commodity or the number thereof by using, as auxiliary information for commodity recognition, the voice received during a predetermined period before and after timing including the timing of detecting that the object is photographed in the step of photographing as the image. Further, the commodity specifying unit 95 registers the commodity or cancels the commodity based on the voice received during the predetermined period before and after timing including the timing of detecting that the object is photographed in the step of photographing as the image.

The final determination notification unit 96 notifies the operator or a customer, by using image output, voice output, etc., of a fact that the commodity and the number thereof are specified by commodity specifying unit. More specifically, the final determination notification unit 96 displays the specified commodity and number thereof on the display 221, and outputs information related to the specified commodity to the speaker 29. The speaker 29 notifies the operator and the customer of the information related to the specified commodity.

As for the commodity specified as described above, the information output unit 97 outputs, to the POS terminal 3, information indicating the commodity (for example, commodity ID, commodity name, discount information, etc.) via the interface 25.

Meanwhile, the information output unit 97 may also output unit sales separately input via the touch panel 222 or the keyboard 23 to the POS terminal 3 together with the commodity ID and the like. Further, as the information to be output from the information output unit 97 to the POS terminal 3, the commodity ID read from the feature amount file 361 by the information output unit 97 may be directly notified. Further, a commodity name that can specify the commodity ID or a commodity image and a file name of the photograph image may be notified to the POS terminal 3, too.

The sales registration unit 99 of the POS terminal 3 registers sales of the corresponding commodity based on the commodity ID and the unit sales output from the information output unit 97. More specifically, the sales registration unit 99 refers to the feature amount file 361, and performs sales registration (temporary registration) by recording, in a sales master file or the like, the notified commodity ID as well as a commodity classification, the commodity name, a unit price, and the unit sales corresponding thereto.

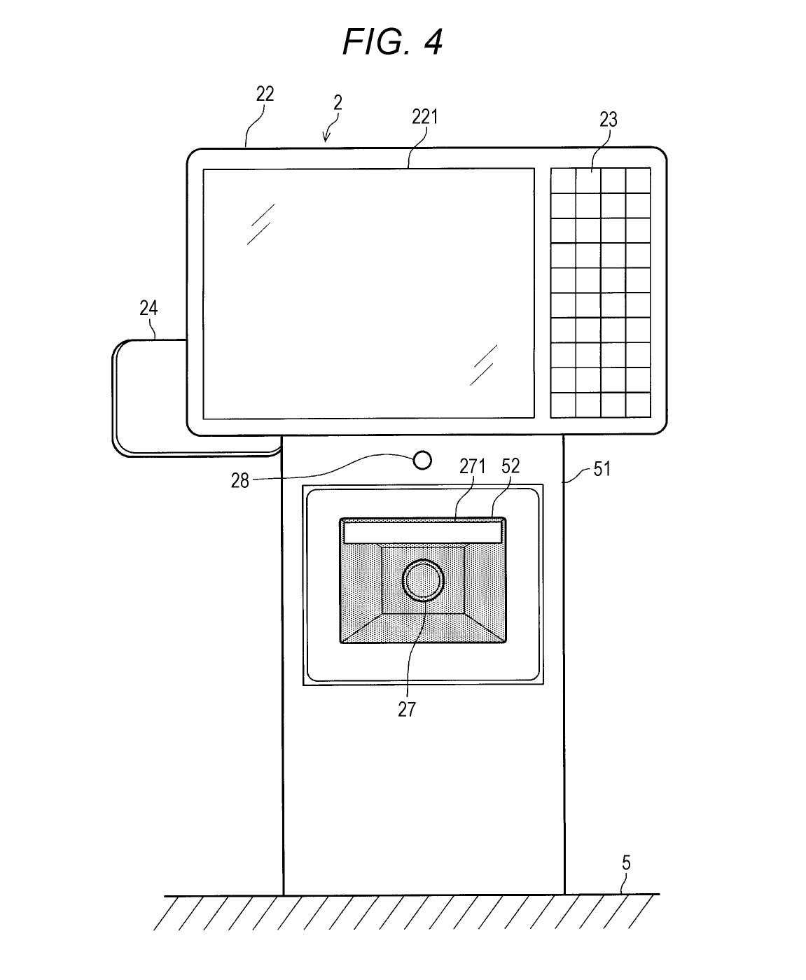

FIG. 4 is a front view of the commodity identification device 2 according to the present embodiment.

The commodity identification device 2 is disposed on the counter table 5. The commodity identification device 2 is formed by including the housing 51 having the shape of the thin rectangular parallelepiped, the display/operation unit 22 mounted above the upper portion of the housing 51, and the customer display 24 disposed on the left back side of the display/operation unit 22 with the back surface thereof facing the display/operation unit 22.

The front surface of the housing 51 is provided with the reading window 52 and the microphone 28, and the microphone 28 is set at a position where the operator's voice utterance is easily picked up. More specifically, the microphone is set on an upper central side of the reading window 52 or on a lower central side of the display 221. When the microphone 28 is set on the upper central side of the reading window 52 or a lower central side of the display 221, a height position of the microphone 28 is positioned close to the operator's face. Therefore, the operator's voice utterance can be picked up well. Further, the setting position of the microphone 28 is the center position of the housing 51, and other voices besides the operator's voice (such as uttered voice of a customer) can be prevented from being picked up.

The reading window 52 is provided with a light 271 and the camera 27 (imaging unit). A recognition area 8M is an area where an object is photographed by the camera 27 and a commodity is specified by detecting the object.

FIG. 5 is a diagram illustrating an exemplary feature amount file 361 according to the present embodiment.

As illustrated in FIG. 5, the feature amount file 361 stores, for each of commodity feature amounts, an image hyper-link destination, voice data, a commodity ID, a unit price, and a commodity name. Note that the image hyper-link destination may also be image data. The voice data corresponds to sample data in the voice recognition DB 362. For example, the feature amount file 361 stores the hyper-link destination such as “N0001F.jpg”, the voice data such as “AOMORI”, the commodity ID such as “N0001”, the unit price such as “100”, and the commodity name such as “Apple produced in AOMORI” as the commodity feature amounts for each of the “feature amount of an AOMORI apple”, “feature amount of a NAGANO apple”, “feature amount of an UNSHU orange”, and “feature amount of an EHIME orange”. As described later, the commodity specifying unit 95 extracts a candidate commodity based on the “commodity feature amounts” obtained by object recognition, and finally determines a corresponding commodity from a “voice recognition result” obtained by voice recognition.

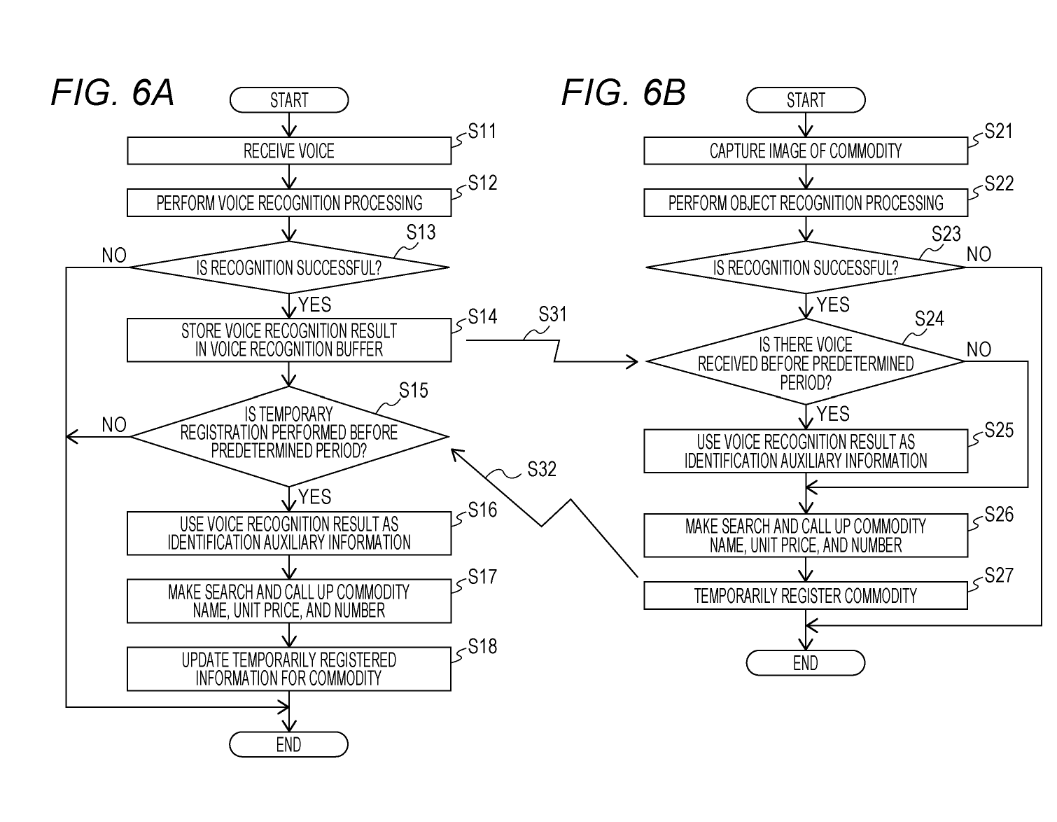

FIGS. 6A and 6B are flowcharts illustrating commodity registration processing according to the present embodiment.

FIG. 6A is a flowchart to perform voice recognition processing and storage of the voice recognition result used as the auxiliary information for commodity recognition. FIG. 6B is a flowchart to perform commodity temporary registration after object recognition processing. The flowchart in FIG. 6A and the flowchart in FIG. 6B are performed in parallel. The respective flowcharts are linked by communication, and cooperative operation is performed between the object recognition processing and the voice recognition result.

The commodity registration processing according to the present embodiment is, for example, a series of the processing in which an operator (shop staff) takes out a commodity from the first shopping basket 4L (refer to FIG. 1) and holds the commodity over the camera 27 of the reading window 52, and then puts the commodity in the second shopping basket 4R.

Note that the present invention may also be applicable to a self-checkout machine in which a customer is the operator.

<Specifying Commodity by Voice Auxiliary Information>

When the operator utters a voice, the voice recognition unit 94 starts processing in Step S11.

In Step S11, the voice recognition unit 94 receives the operator's voice utterance from the microphone 28. In the case where a voice level uttered by the operator is a predetermined value or more, the voice recognition unit 94 determines that the voice is received. More specifically, an example in which the operator utters “AOMORI” will be described first.

In Step S12, the voice recognition unit 94 analyzes waveforms of a voice signal of the voice uttered by the operator, and extracts a feature pattern to recognize the voice. Here, the voice recognition unit 94 recognizes the operator's voice utterance of “AOMORI”.

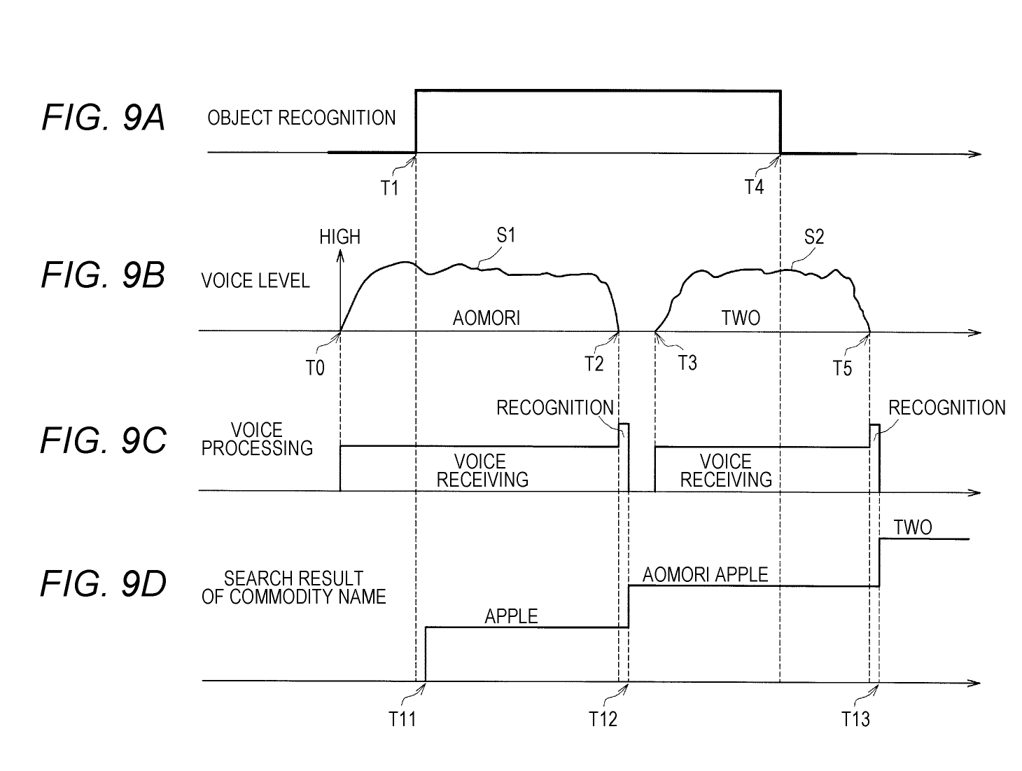

A specific example of voice recognition will be described with reference to FIGS. 9A to 9D.

FIG. 9B is a timing chart illustrating received voice level (high/low) of a voice signal. The voice signal of FIG. 9B is represented by a simple envelope for sake of description. Further, when the voice level is less than a predetermined value (for example, zero level), it is assumed that there is no voice signal received. When the voice level is the predetermined value or more, it is determined that there is the voice signal received. Actually, an appropriate predetermined value is set considering a noise component.

As illustrated in FIG. 9B, a first voice signal 51 from time T0 has a high voice level, and receipt of the first voice signal 51 is finished at time T2. After that, at time T2 when the voice level of the first voice signal 51 is lowered (to zero level), the voice recognition unit 94 acquires the voice signal 51 that has started utterance at time T0 and analyzes waveforms as illustrated in FIG. 9C.

Further, the voice recognition unit extracts the feature pattern and recognizes the voice (Step S12 in FIG. 6A). Such voice recognition processing requires a predetermined period, and is finished at time T12 illustrated in FIG. 9D.

Referring back to the flow in FIG. 6A, the voice recognition unit 94 determines whether voice recognition is successful in Step S13, and in the case where voice recognition is not successful, this flow ends.

In the case where the voice recognition is successful (Yes), the voice recognition unit 94 stores a voice recognition result in the voice recognition buffer 941 (refer to FIG. 7) in Step S14. In the case of the example in FIG. 7, the voice recognition buffer 941 stores the voice recognition result of “AOMORI” uttered by the operator. Further, as illustrated by a reference sign S31 in FIGS. 6A and 6B, the voice recognition result of “AOMORI” stored in the voice recognition buffer 941 is referenced in the processing in Step S24.

In Step S15, the commodity specifying unit 95 determines whether the result of commodity temporary registration performed by the flow from object recognition to temporary registration (refer to FIG. 6B) is acquired and temporarily registered before the predetermined period as indicated by a reference sing S32 illustrated in FIGS. 6A and 6B.

In the case where temporary registration is not performed before the predetermined period (No), the flow from the voice recognition to the temporary registered information updating ends.

Here, the commodity obtained by the object recognition is not temporarily registered. Therefore, the voice recognition result of “AOMORI” is stored in the voice recognition buffer 941, and the flow ends.

Meanwhile, in the case where temporary registration is performed before the predetermined period (Yes), the processing proceeds to subsequent steps from Step S16. Steps S16 to 18 will be described later.

Next, the flowchart from object recognition to temporary registration in FIG. 6B, which is performed in parallel to the flowchart in FIG. 6A, will be described.

The operator utters “AOMORI” and also holds the commodity “apple” over the camera 27.

When the operator holds the commodity over the camera 27, the image acquisition unit 90 starts processing in Step S21.

In Step S21, the image acquisition unit 90 outputs an image capturing ON signal to the camera 27, and starts capturing (image capturing) of a commodity image by the camera 27. The image acquisition unit 90 acquires a frame image (captured image) that has been captured by the camera 27 and stored in the RAM 213.

FIG. 9A is the timing chart illustrating start timing and finish timing for object recognition. During a period from start of object recognition processing (time T1) to finish thereof (time T4), the object is recognized by capturing each of frame images. In the present embodiment, the object detection unit 91 sets a specific period including a period from start of object recognition processing to determination of a similarity level by the determination unit 93 as a period from start of object recognition processing (time T1) to finish thereof (time T4).

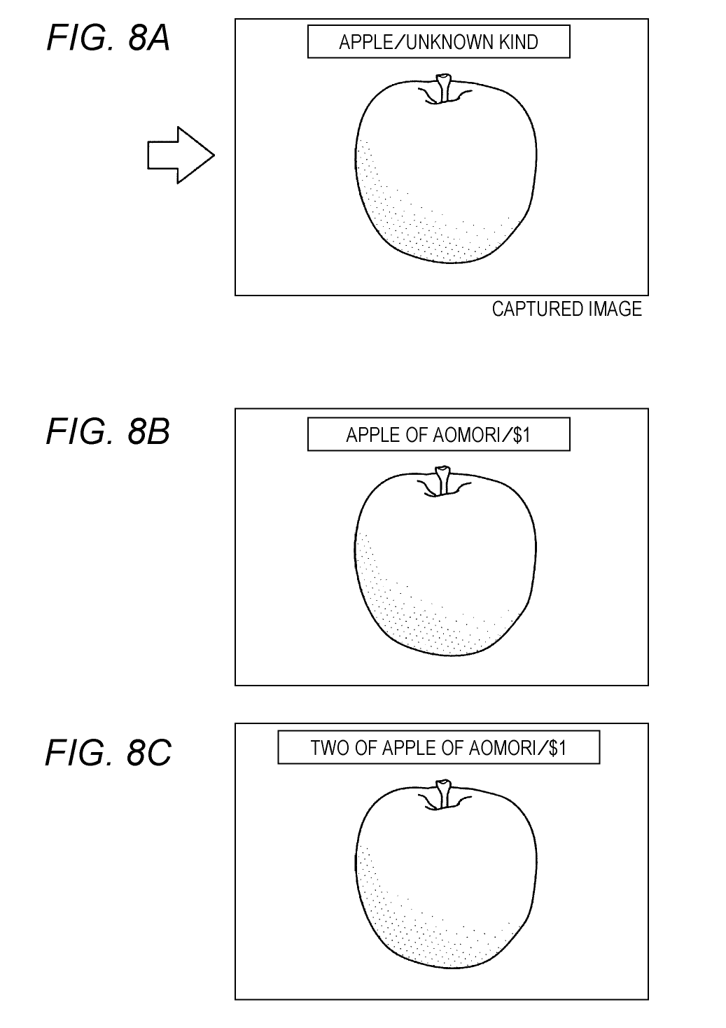

FIG. 8A is a diagram illustrating an exemplary confirmation screen displayed on the display 221. An arrow in FIG. 8A indicates the operator's movement in commodity registering operation in which the operator takes out the commodity from the first shopping basket 4L and holds the commodity over the camera 27 of the reading window 52. For example, the camera 27 captures an image of the commodity “apple” and stores the image as the frame image (captured image) in the RAM 213.

Referring back to the flowchart in FIG. 6B, in Step S22, the object detection unit 91 performs object recognition processing for the frame image acquired by the image acquisition unit 90, and attempts to recognize (detect) an entire portion or a part of the object corresponding to the commodity.

In Step S23, the object detection unit 91 determines whether the entire portion or a part of the object corresponding to the commodity is successfully recognized. In the case where the object corresponding to the commodity is successfully recognized (Yes), the object detection unit 91 proceeds to the processing in Step S24. In the case where the object corresponding to the commodity is not successfully recognized (No), the flowchart ends. More specifically describing Steps S21 to S23, these Steps correspond to a series of the processing in which the operator holds the commodity over the camera 27 of the reading window 52 and the commodity identification device 2 succeeds in detecting the object corresponding to the commodity.

In the case where object recognition is successful in above Step S23 (Yes), the commodity specifying unit 95 determines, in Step S24, whether there is voice received before the predetermined period based on the voice recognition result in the voice recognition buffer 941.

In this case, the voice recognition result of “AOMORI” is stored in the voice recognition buffer 941, and it is determined by referring to the voice recognition result in Step S24 that there is the voice received before the predetermined period (Yes).

In the case where there is the voice received before the predetermined period, the commodity specifying unit 95 uses the voice recognition result as the identification auxiliary information in Step S25. More specifically, the commodity specifying unit 95 uses the voice recognition result of “AOMORI” as the auxiliary information.

Referring back to FIG. 6B, in Step S26, the commodity specifying unit 95 searches a commodity master file (sales master file) for the commodity name, price, and number thereof based on the identification auxiliary information, and calls up these information.

More specifically, the commodity specifying unit 95 searches the commodity master file (sales master file) for the commodity name “AOMORI apple” and the commodity unit price “$1” of the commodity, and calls up these information. By this, the specified commodity name “AOMORI apple” and the commodity unit price “$1” are displayed on the display 221 as illustrated in FIG. 8B.

In Step S27, the information output unit 97 outputs, to the POS terminal 3, a commodity ID and the like of a finally determined handling commodity so as to be temporarily registered. By this, the sales registration unit 991 of the POS terminal 3 temporarily registers the commodity based on the commodity ID. At this point, the final determination notification unit 96 displays, on the display 221, a final determination screen including the photograph image of the finally determined commodity, and further notifies the commodity name of the finally determined commodity by a voice. When the processing in Step S27 ends, the processing in FIGS. 6A and 6B ends.

Further, in Step S27, the commodity specifying unit 95 records a result of commodity temporary registration, and the result is referenced in the processing of Step S15 as indicated by the reference sing S32 illustrated in FIGS. 6A and 6B.

<Determining Number of Commodity by Voice Auxiliary Information>

After the predetermined period including the timing of recognizing the commodity “AOMORI apple”, in the case where voice utterance of “two” is received again, the following processing is performed.

When the operator utters the voice again, the voice recognition unit 94 starts the processing in Step S11.

In Step S11, the voice recognition unit 94 receives the operator's voice utterance from the microphone 28. In the case where a voice level uttered by the operator is a predetermined value or more, the voice recognition unit 94 determines that the voice is received.

Here, as illustrated in FIG. 9B, receipt of a second voice signal S2 is started from time T3 and finished at time T5. The second voice signal S2 is “two”.

In Step S12, the voice recognition unit 94 analyzes waveforms of the voice signal of the voice uttered by the operator, and extracts a feature pattern to recognize the voice. The voice recognition unit 94 recognizes the operator's voice utterance of “two” from time T5 to time T13 as illustrated in FIG. 9D. Note that “two” is uttered during the predetermined period (e.g., three seconds) after temporary registration of “AOMORI apple”.

In Step S13, the voice recognition unit 94 determines whether voice recognition is successful.

When the voice recognition is successful (Yes), the voice recognition unit 94 stores a voice recognition result in the voice recognition buffer 941 (refer to FIG. 7) in Step S14. In this case, the voice recognition buffer 941 stores the voice recognition result of “two” uttered by the operator.

In Step S15, the commodity specifying unit 95 determines whether the result of commodity temporary registration performed by the flow from object recognition to temporary registration (refer to FIG. 6B) is acquired and temporarily registered before the predetermined period as indicated by a reference sing S32 illustrated in FIGS. 6A and 6B. In this case, the commodity “AOMORI apple” is temporarily registered by the processing in Step S27. Therefore, the commodity specifying unit 95 determines that temporary registration is performed before the predetermined period (Yes), and the processing proceeds to Step S16.

The commodity specifying unit 95 acquires the voice recognition result of “two” stored in the voice recognition buffer 941. Therefore, the commodity specifying unit 95 determines that there is voice received before the predetermined period in Step S24 (Yes).

In Step S16, the commodity specifying unit 95 uses the voice recognition result as the identification auxiliary information. Here, the voice recognition result of “two” is the auxiliary information.

In Step S17, the commodity specifying unit 95 searches the commodity master file (not illustrated) for the commodity name, unit price, and number thereof based on the identification auxiliary information, and calls up these information. More specifically, the number of commodities is determined for the specified commodity “AOMORI apple” by using the voice recognition result of “two” as the auxiliary information.

In Step S18, the commodity specifying unit 95 updates the temporary registered information of the commodity, and this flow ends.

Referring again to FIGS. 8 and 9A to 9D, an example of specifying the commodity by using, as the identification auxiliary information, the voice recognition result obtained by receiving the voice again.

As for the specified commodity “AOMORI apple”, the number is determined for by receiving the voice again and performing the voice recognition processing therefor. For example, when the operator utters the voice “two” and the voice recognition unit 94 recognizes the voice as “two”, the number of the specified commodity “AOMORI apple” is determined as two (two apples). As illustrated in FIG. 9D, a commodity name search result does not include specification of the number before time T13, but the number is determined as “two” after time T13. Consequently, it is determined that there are “two” of the commodity name “AOMORI apple”. By this, the commodity identification device 2 can finally determine the commodity name and the number of the commodity “AOMORI apple”.

Meanwhile, the example in FIGS. 9A to 9D is a case where the number is determined when object recognition to specify the commodity is not successful. Here, in the case where object recognition is not successful, voice recognition is not needed to be performed, and a case where the commodity is uniquely specified is included as well. More specifically, in the case where there is only one kind of the commodity “apple”, the operator can omit voice utterance of “AOMORI” to specify the commodity name. Thus, the operator can only input the number by voice.

Although not illustrated in FIG. 9B, the first voice signal S1 is eliminated, and the voice utterance of “AOMORI” is replaced by the voice utterance of “two” in the second voice signal S2 (time T13). Here, the voice utterance of “AOMORI” before the second voice signal S2 (time T13) is replaced by voice utterance of “cancel”, thereby achieving to cancel commodity registration in the same processing described above.

Further, a plurality of voices may be set in the “voice” of the feature amount file 361 illustrated in FIG. 5 such that a commodity can be specified even in the case of recognizing any one of these voices. For example, in the case of the commodity “apple”, “TSUGARU” may be set in addition to a production area name “AOMORI”, the commodity “AOMORI apple” is specified in the same manner as the case where the voice “AOMORI” is uttered even when a voice “TSUGARU” is uttered. Further, the “voice” of the feature amount file 361 in FIG. 5 may be a nickname or a common name besides the production area. For example, in the case of “orange”, a common name “UNSHU” may be set in addition to the production area name “WAKAYAMA”, the commodity “UNSHU orange” is specified in the same manner as the case where a voice “WAKAYAMA” is uttered when a voice “UNSHU” uttered.

According to the commodity registration processing, the operator can perform sales registration, additional registration/cancelation for the commodity without operating the keyboard. Particularly, specifying a commodity based on a commodity production area, specifying the number, canceling a commodity, etc. can be easily performed although such operations have been difficult to be performed only by performing object recognition using an image. As a result, work efficiency can be highly improved.

In other words, according to the present embodiment, a photographing unit photographs an object as an image. Further, a voice input unit is configured capable of receiving a voice. Additionally, a control unit is configured to recognize a commodity by using, as auxiliary information to recognize an object as a commodity, the voice received from the voice input unit during a predetermined period before and after timing including the timing of detecting that the object is photographed by the photographing unit as the image.

At this point, the control unit uses the voice input by the voice input unit as the auxiliary information at the time of recognizing a commodity based on the image.

Further, the control unit uses the auxiliary information as number information of the object at the time of recognizing the object as the commodity.

Further, the control unit uses the auxiliary information as production area information of the object at the time of recognizing the object as the commodity.

Furthermore, the control unit uses the auxiliary information as cancel information of registering the object as a commodity at the time of recognizing the object as the commodity.

### Modified Example

The present invention is not limited to the above-described embodiment and can be modified within a range not departing from the gist of the present invention. For example, following (a) and (b) may be applied.

(a) A voice to be recognized may be any kind. For example, the voice may be a “nickname (common name)”, “number”, and further “cancel”, or may be a combination thereof. Further, times and order of the voice recognition may be optional.

(b) A period during which a commodity photographed by the camera 27 is recognized at least overlaps a period during which the voice is input from the microphone 28 and recognized, and how these periods overlap does not matter. For example, as illustrated in FIG. 9A, at least any part of the period from the start of object recognition (time T1) to the finish thereof (time T4) overlaps. Further, the period during which the voice is recognized may entirely overlap the period from the start of object recognition (time T1) to the finish thereof (time T4).

1. A commodity registration device, comprising:
a photographing unit configured to photograph an object as an image;
a voice input unit configured to receive a voice; and
a control unit configured to recognize a commodity by using, as auxiliary information to recognize the object as a commodity, the voice received from the voice input unit during a predetermined period before and after timing including the timing of detecting that the object is photographed by the photographing unit as the image.

2. The commodity registration device according to claim 1, wherein the control unit uses the voice received from the voice input unit as auxiliary information at the time of recognizing a commodity based on the image.

3. The commodity registration device according to claim 1, wherein the control unit uses the auxiliary information as number information of the object at the time of recognizing the object as the commodity.

4. The commodity registration device according to claim 1, wherein the control unit uses the auxiliary information as production area information of the object at the time of recognizing the object as the commodity.

5. The commodity registration device according to claim 1, wherein the control unit uses the auxiliary information as cancel information of registering the object as a commodity at the time of recognizing the object as the commodity.

6. The commodity registration device according to claim 1, including a display unit on which predetermined information is displayed,
wherein the control unit displays the recognized auxiliary information on the display unit every time the auxiliary information is recognized.

7. The commodity registration device according to claim 6, wherein the control unit display the auxiliary information and the image on the display unit such that the auxiliary information is displayed on an upper side of the image.

8. The commodity registration device according to claim 1, wherein the voice input unit is disposed at a position higher than the photographing unit.

9. The commodity registration device according to claim 1, including a display on which predetermined information is displayed,
wherein the voice input unit is disposed between the photographing unit and the display.

10. A commodity registration device, comprising:
a camera configured to photograph an object as an image;
a microphone configured to receive a voice; and
a processor configured to recognize a commodity by using, as auxiliary information to recognize the object as a commodity, the voice received from the microphone during a predetermined period before and after timing including the timing of detecting that the object is photographed by the camera as the image.

11. The commodity registration device according to claim 10, wherein the processor uses the voice received from the microphone as auxiliary information at the time of recognizing a commodity based on the image.

12. The commodity registration device according to claim 10, wherein the processor uses the auxiliary information as number information of the object at the time of recognizing the object as the commodity.

13. The commodity registration device according to claim 10, wherein the processor uses the auxiliary information as production area information of the object at the time of recognizing the object as the commodity.

14. The commodity registration device according to claim 10, wherein the processor uses the auxiliary information as cancel information of registering the object as a commodity at the time of recognizing the object as the commodity.

15. The commodity registration device according to claim 10, including a display on which predetermined information is displayed,
wherein the processor displays the recognized auxiliary information on the display every time the auxiliary information is recognized.

16. The commodity registration device according to claim 15, wherein the auxiliary information and the image are displayed on the display such that the auxiliary information is displayed on an upper side of the image.

17. A commodity registration method, comprising steps of:
photographing an object as an image;
receiving a voice; and
performing control to recognize a commodity by using, as auxiliary information to recognize the object as a commodity, the voice received in the step of receiving a voice during a predetermined period before and after timing including the timing of detecting that the object is photographed in the step of photographing as the image.

18. The commodity registration method according to claim 17, wherein the step of performing control uses the voice received in the step of receiving a voice as auxiliary information at the time of recognizing a commodity based on the image.

19. The commodity registration method according to claim 17, wherein the step of performing control uses the auxiliary information as number information of the object at the time of recognizing the object as the commodity.

20. The commodity registration method according to claim 17, wherein the step of performing control uses the auxiliary information as production area information of the object at the time of recognizing the object as the commodity.
